(19) United States
(12) Patent Application Publication
(10) Pub. No.: US 2024/0165826 A1
(43) Pub. Date: May 23, 2024

(54) CLAMPING DEVICE AND CLAMPING ROBOT HAVING THE SAME

(71) Applicant: SHENZHEN JINGTAI TECHNOLOGY CO., LTD., Shenzhen (CN)

(72) Inventors: Kaiping FAN, Nanping City (CN); Yang LIU, Shenzhen (CN)

(21) Appl. No.: 18/396,598

(22) Filed: Dec. 26, 2023

Related U.S. Application Data
(63) Continuation of application No. PCT/CN2022/141325, filed on Dec. 23, 2022.

(30) Foreign Application Priority Data
Dec. 31, 2021 (CN) 202111676970.X

(51) Int. Cl. B25J 15/00

(52) U.S. Cl. CPC B25J 15/0038; B25J 15/0042

(57) ABSTRACT

The present disclosure relates to a clamping device and a clamping robot having the same. The clamping device includes a body, a first driving member arranged on the body, and a first gripper assembly and a second gripper assembly which are arranged independently. The first driving member is drive-connected to the first gripper assembly and the second gripper assembly respectively so as to drive the first gripper assembly and the second gripper assembly to clamp an object separately. According to the solution provided in the present disclosure, the overall volume of the clamping device can be reduced and the scope of application of the clamping device can be expanded.

### CROSS-REFERENCE TO RELATED APPLICATIONS

The present application claims priority to Chinese Patent Application No. 202111676970.X filed with the China National Intellectual Property Administration on Dec. 31, 2021, entitled clamping device and clamping robot having the same, the contents of which are all incorporated herein by reference in their entireties.

### FIELD OF THE INVENTION

The present application relates to the technical field of clamping apparatus, in particular to a clamping device and a clamping robot having the same.

### DESCRIPTION OF THE RELATED ART

When conducting experiments in the laboratory, it is usually necessary to use a clamping device to grab the container. The clamping device is usually equipped with two independent groups of gripper assemblies. When it is needed to clamp the object, one or both of the groups of gripper assemblies can be selected to clamp the object based on the type of the object or the circumstance in which the object is located. The clamping device usually also includes two groups of driving assemblies, and the driving assemblies and gripper assemblies are arranged in a one-to-one correspondence manner. The driving assemblies are drive-connected to the gripper assemblies to clamp the object independently. However, this arrangement results in a larger volume of the clamping device, which in turn make the clamping device occupy a larger space and makes it inconvenient to clamp objects in corners.

### SUMMARY

In a first aspect, the present disclosure provides a clamping device. The clamping device includes a body, a first driving member arranged on the body, and a first gripper assembly and a second gripper assembly which are arranged independently. The first driving member is drive-connected to the first gripper assembly and the second gripper assembly respectively so as to drive the first gripper assembly and the second gripper assembly to clamp an object separately.

In a second aspect, the present disclosure provides a clamping robot. The clamping robot includes a motion mechanism and a clamping device described above. The motion mechanism is drive-connected to the clamping device to drive the clamping device to move.

The clamping device according to some embodiments of the present disclosure is provided with a first gripper assembly and a second gripper assembly. When it is needed to clamping an object, the first gripper assembly or the second gripper assembly can be selected to clamp the object based on the type of the object or the circumstance in which the object is located. Compared with traditional technical solutions, by using the first driving member to drive both of the first gripper assembly and the second gripper assembly to clamp the object independently, the number of the driving member can be reduced, thereby reducing the overall volume of the clamping device, which can make the clamping device miniaturized and facilitate the clamping device to clamp objects at corners.

It should be understood that the foregoing general description and the following detailed description are illustrative and explanatory only and do not limit the present disclosure.

### BRIEF DESCRIPTION OF THE DRAWINGS

By providing a more detailed description of the exemplary embodiments of the present disclosure in combination with the accompanying drawings, the foregoing and other purposes, features, and advantages of the present disclosure will become more apparent. In the exemplary embodiments of the present disclosure, the same reference numerals usually represent the same component.

FIG. 1 is a view showing the clamping device according to an embodiment of the present disclosure;

FIG. 2 is a view showing the clamping device according to an embodiment of the present disclosure, with the lifting plate being lifted up;

FIG. 3 is a view showing the clamping device according to an embodiment of the present disclosure, viewing from another perspective;

FIG. 4 is a view showing the cooperation of the main body part and the clamping rod according to an embodiment of the present disclosure;

FIG. 5 is a view showing the clamping rod according to an embodiment of the present disclosure;

FIG. 6 is a main view showing the cooperation of the main body part and the clamping rod according to an embodiment of the present disclosure;

FIG. 7 is a top view showing the cooperation of the main body part and the clamping rod according to an embodiment of the present disclosure;

FIG. 8 is a side view showing the cooperation of the main body part and the clamping rod according to an embodiment of the present disclosure;

In above figures, following reference numerals are included.
10: body; 11: second limit part
20: first driving member
30: first clamping portion; 31: first anti-slip structure;
41: main body part; 42: clamping rod; 4221: cut surface for wrench; 4222: clamping groove; 4223: second anti-slip structure; 4224: second elastic member;
50: connecting part;
61: guide slot;
71: second driving member; 72: lifting plate; 721: first limit part; 73: screw rod; 74: screw nut pair; 75: connecting block; 751: baffle
80: guide rod;
91: quick-change connecting plate; 92: quick-change connector.

### DETAILED DESCRIPTION OF THE EMBODIMENTS

Some embodiments of the present disclosure will be described in more detail below with reference to the accompanying drawings. Although some embodiments of the present disclosure are shown in the accompanying drawings, it should be understood that the present disclosure can be implemented in various forms and should not be limited by the embodiments described here. On the contrary, these embodiments are provided to make the present disclosure more thorough and complete, and to fully convey the scope of the present disclosure to ones skilled in the art.

The terms used in the present disclosure are for the purpose of describing specific embodiments only and are not intended to be limit of the present disclosure. The singular forms of “a”, “said”, and “the” used in the present disclosure and the accompanying claims are intended to include the plural forms as well, unless the context clearly indicates other meanings. It should also be understood that the term “and/or” used herein includes any or all possible combinations of one or more related listed items.

It should be understood that although the terms “first,” “second,” “third,” etc. may be used herein to describe various information, the information should not be limited to these terms. These terms are only used to distinguish the same type of information from each other. For example, without departing from the scope of the present disclosure, first information can also be referred to as second information, and similarly, second information may also be referred to as first information. Therefore, a feature defines as “first” or “second” can explicitly or implicitly include one or more of that feature. In the description of the present disclosure, “a plurality of” means two or more, unless otherwise specified.

According to a clamping device and a clamping robot having the same provided in some embodiments of the present disclosure, the overall volume of the clamping device can be reduced and the scope of application of the clamping device can be expanded.

Technical solutions according to some embodiments of the present disclosure will be described in detailed in combination with the accompanying drawings.

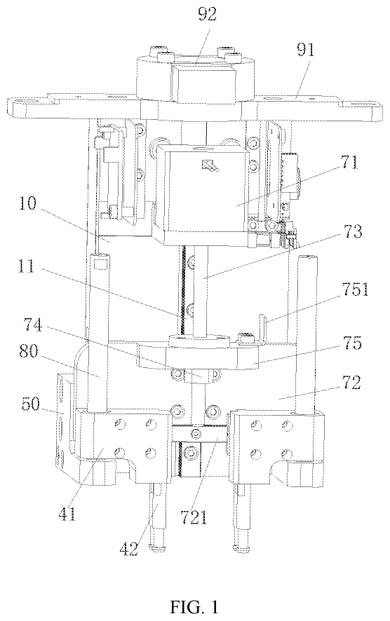

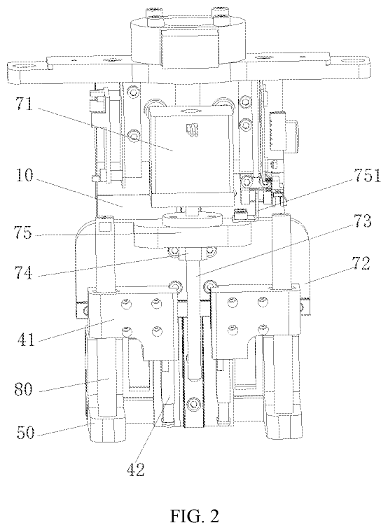

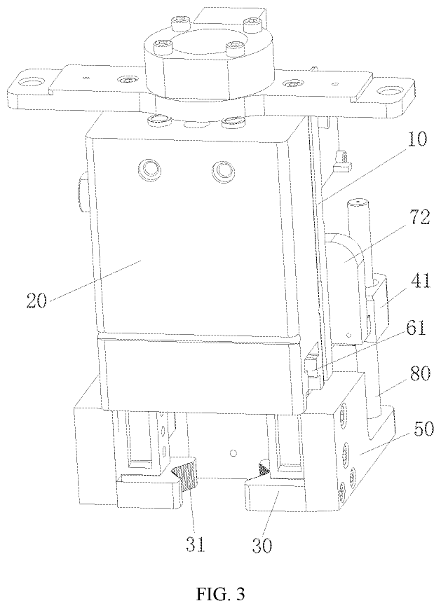

Referring to FIGS. 1 to 3, a clamping device according to an embodiment of the present disclosure includes a body 10, a first driving member 20, and a first gripper assembly and a second gripper assembly which are arranged independently. The first driving member 20 is arranged on the body 10. The first driving member 20 is drive-connected to the first gripper assembly and the second gripper assembly respectively so as to drive the first gripper assembly and the second gripper assembly to clamp an object separately. The first driving member 20 is, for example, an electric motor or a cylinder.

According to the above technical solution, the clamping device is provided with a first gripper assembly and a second gripper assembly. When it is needed to clamping an object, the first gripper assembly or the second gripper assembly can be selected to clamp the object based on the type of the object or the circumstance in which the object is located. Compared with traditional technical solutions, in this embodiment, the first gripper assembly and the second gripper assembly are both driven by the first driving member 20, thereby reducing the number of the driving members and the size of the clamping device, facilitating to clamp the objects at corners, and reducing the weight and cost of the clamping device. Moreover, the first gripper assembly and the second gripper assembly can perform gripping actions independently, facilitating the taking and placing of different types of objects and expanding the application scope of the clamping device.

The first gripper assembly and the second gripper assembly may have the same structure, or have different structures. In this embodiment, the first gripper assembly and the second gripper assembly have different structures. By this configuration, the clamping device can take different types of objects, further expanding the applicable scenarios of the clamping device and expanding its application scope. Moreover, the first gripper assembly and the second gripper assembly are located at two sides of the body 10 respectively. The first gripper assembly and the second gripper assembly may be located at two adjacent sides of the body 10 respectively, or located at two opposite sides of the body 10 respectively, or located at the same side of the body 10. In this embodiment, the body 10 extends in the vertical direction. The first gripper assembly and the second gripper assembly are located at two opposite sides of the body 10 respectively. By this configuration, mutual interference between the first gripper assembly and the second gripper assembly during operation can be avoided, improving the flexibility of the clamping device. The position of at least one of the first gripper assembly and the second gripper assembly relative to the body 10 is adjustable. In this embodiment, the position of the second gripper assembly relative to the body 10 is adjustable. When using the second gripper assembly to clamp the object, the second gripper assembly is adjusted to a suitable position, then the object is clamped by the second gripper assembly. After clamping is completed, the position of the second gripper assembly can be adjusted again as needed to complete the entire clamping action. By this configuration, the flexibility of the clamping device can be further improved, its application scope can be expanded, facilitating taking and placing of the objects.

In an implementation, the first gripper assembly includes a plurality of first clamping portions 30. Each of the first clamping portions 30 has a first clamping surface, and the plurality of first clamping portions 30 are in cooperation with each other through a plurality of first clamping surfaces to clamp the object. When it is needed to clamp an object, the plurality of first clamping portions 30 of the first gripper assembly approach the object to be clamped until the plurality of first clamping surfaces are all in contact with the object to be clamped. By arranging the plurality of clamping portions, objects of different sizes and different shapes can be clamped, improving the adaptability of the first gripper assembly.

In an implementation, a contact region between the first clamping surface of the first clamping portion 30 and the clamped object is at a cambered surface or a planar surface of the first clamping surface. Alternatively, there are a plurality of contact regions between the first clamping surface of the first clamping portion 30 and the clamped object, and an angle is formed between the plurality of contact regions of the first clamping surface. By this configuration, the contact area between the first clamping surface and the clamped object can be increased, further improving the stability of the first gripper assembly when clamping the clamped object.

In this embodiment, the first clamping portion 30 is in a block structure, and the number of the first clamping portions 30 is two. The two first clamping portions 30 are arranged opposite each other. The first clamping surface of the first clamping portion 30 is V-shaped. By this configuration, the uniformity of the force on the clamped object can be ensured, and the stability when clamping the clamped object can be ensured. Moreover, the two V-shaped first clamping surfaces are arranged opposite each other, which realizes the clamping of objects of different sizes and shapes and expands the application scope of the first gripper assembly.

In some embodiments, the first gripper assembly further includes at least one of a first anti-slip structure 31 and a first elastic member. In the case that the first gripper assembly includes a first elastic member, the first elastic member can be an elastic pad made of rubber, and the first elastic member is provided on the first clamping surface. By providing the first elastic member, the rigid contact between the first clamping portion 30 and the object can be avoided, reducing the possibility of the clamped object being crushed. In the case that the first gripper assembly includes a first anti-slip structure 31, the first anti-slip structure 31 is provided on the first clamping surface. The first anti-slip structure 31 can be a first anti-slip pattern, a first anti-slip particles, or a first anti-slip pad. By providing the first anti-slip structure 31, the friction force between the first clamping portion 30 and the clamped object can be increased, improving the stability of the first clamping portion 30 when clamping the object. The first anti-slip pattern can be inclined stripes, vertical stripes, horizontal stripes, or grid stripes, and this solution does not limit the specific form of stripes. In this embodiment, the first gripper assembly includes a first anti-slip structure 31 which is a first anti-slip pattern provided on the first clamping surface, and the first anti-slip pattern is a vertical striped structure.

In an implementation, the second gripper assembly includes a plurality of clamping rods 42 which cooperate with each other to clamp the object. In this embodiment, the clamping rod 42 extend in the vertical direction, and the plurality of clamping rods 42 are distributed in a circular shape. When the object is to be clamped by the second gripper assembly, the first driving member 20 drive the plurality of clamping rods 42 close to the object to be clamped until the clamping rods 42 are all abutted with the object, and the plurality of clamping rods 42 complete clamping the object. By this configuration, the contact area between the clamping rods 42 and the clamped object can be increased, improving the stability of the second gripper assembly when clamping the clamped object. Moreover, in this arrangement, the plurality of clamping rods 42 is reasonably distributed, which can reduce the space occupied by the second gripper assembly and facilitate extending the plurality of clamping rods 42 to the periphery of the object to perform the clamping action, improving the flexibility when clamping the object.

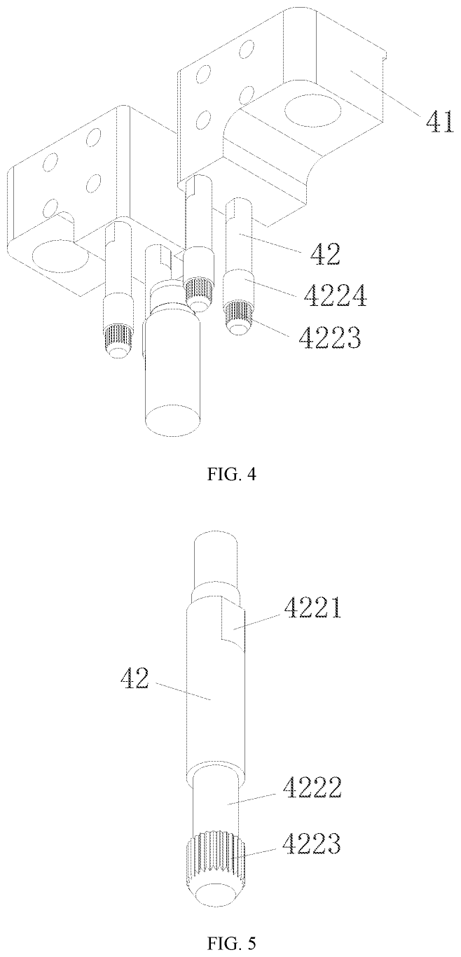

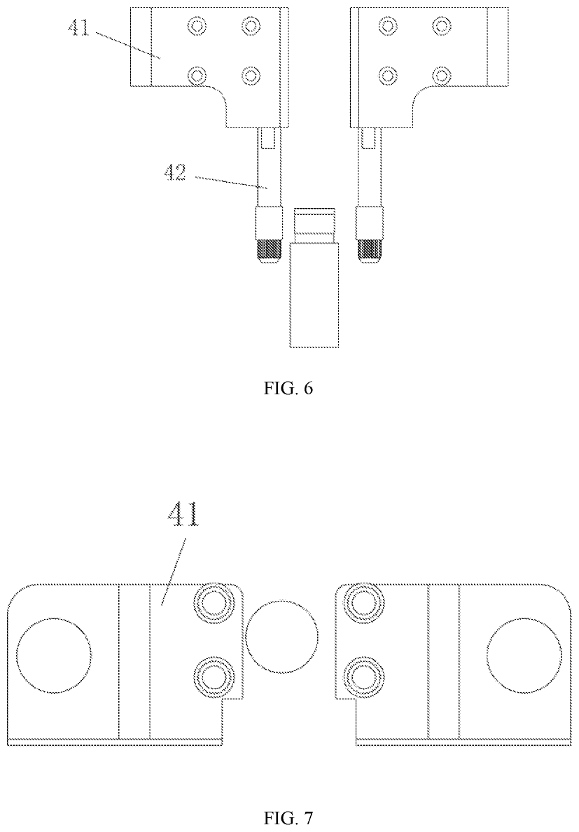

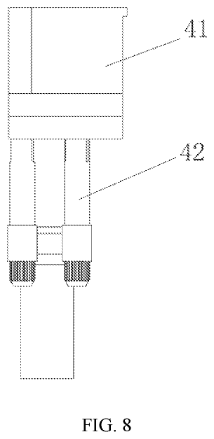

As shown in FIGS. 4 to 8, the clamping rod 42 includes a first clamping segment. The first clamping segment has a second clamping surface which is used for clamping the object. The second clamping surface of at least one of the clamping rods 42 is a planar surface or a cambered surface. In this embodiment, the first clamping segment of the clamping rod 42 is at the lower end of the clamping rod 42, and all of the second clamping surfaces of the plurality of second clamping rods 42 are cambered surfaces. The axis direction of the second clamping surface is in the vertical direction. By this configuration, the second clamping surfaces of the plurality of clamping rods 42 can all make contact with the clamped object when the plurality of clamping rods 42 clamp the object, thereby improving the stability of the second gripper assembly in clamping the object.

In an implementation, a second anti-slip structure 4223 is provided on the second clamping surface. By providing the second anti-slip structure 4223, the friction force between the second clamping surface and the clamped object can be increased, improving the stability of the second gripper assembly in clamping the clamped object. The second anti-slip structure 4223 is a second anti-slip pattern, and the second anti-slip pattern is provided on the second clamping surface. The second anti-slip pattern can be an inclined pattern or a grid pattern, and this scheme does not limit the specific shape of the pattern. In this embodiment, the second anti-slip structure 4223 is a vertical anti-slip pattern.

In an implementation, the clamping rod 42 is a column, and the number of the clamping rods 42 is three or more. In this embodiment, the peripheral surface of the clamping rod 42 forms the second clamping surface, and the second anti-slip patterns are distributed on the second clamping surface in a circular shape. In this embodiment, the number of the clamping rods 42 is four, and the four clamping rods 42 are arranged in pairs opposite each other and distributed in a circular shape. By this configuration, four clamping rods 42 can be circularly distributed around the outer peripheral of the clamped object, ensuring the uniformity of the force on the object and improving the stability in clamping the object.

In an implementation, the clamping rod 42 further includes a second clamping segment which is connected to the first clamping segment and is located above the first clamping segment. A second elastic member 4224 is provided on the second clamping segment. The second clamping segment is provided with a clamping groove 4222. The clamping groove is in a circular structure. The second elastic member 4224 is also in a circular structure. The second elastic member 4224 is clamped to the second clamping segment through the clamping groove 4222. The peripheral surface of the second elastic member 4224 protrudes from the second clamping segment. When it is needed to clamp containers that are easily damaged or containers with a longer bottle body, the second clamping segment can be used. When it is needed to clamp containers that are not easily damaged or containers with a shorter bottle body, the first clamping segment can be used. This configuration facilitates to clamp different types of containers by the second gripper assembly, improving the adaptability of the clamping device. The second elastic member 4224 is, for example, a rubber sleeve.

As shown in FIGS. 1 to 3, the second gripper assembly further includes a plurality of main body parts 41. Each of the plurality of main body parts 41 is connected to at least one clamping rod 42. The clamping rod 42 is below the main body part 41. The first driving member 20 is drive-connected to the main body part 41. The first driving member 20 drives the clamping rod 42 to move through the main body part 41. The clamping rod 42 is detachably connected to the main body part 41. The clamping rod 42 can be detachably connected to the main body part 41 by clamping or through a fastener. In this embodiment, the bottom of the main body part 41 is provided with threaded holes, and the top of the clamping rod 42 is in threaded connection with the main body part 41 through the threaded hole. This configuration facilitates the replacement of the clamping rods 42 with different specifications and sizes so that different types of clamping rods 42 can be selected to clamp different types of objects to be clamped, improving the adaptability of the clamping device. In this embodiment, the peripheral surface the clamping rod 42 near the top is provided with a cut surface 4221 for wrench which facilitates to clamp the clamping rod 42.

In some embodiments, the clamping device further includes a plurality of connecting parts 50. Each of the connecting parts 50 is connected to at least one of the main body parts 41. The first driving member 20 is drive-connected to the connecting part 50, and the first driving member 20 drives the main body part 41 to move through the connecting part 50. When it is needed to clamp an object, the first driving member 20 drives the connecting part 50 to move, the connecting part 50 drives the main body part 41 to move when it moves, and when the main body part 41 moves, it drives the clamping rods 42 to move so as to complete clamping the object.

In an implementation, the connecting part 50 includes a first connecting segment and a second connecting segment connected at an included angle, the first driving member 20 is connected to the first connecting segment of the connecting part 50, and the second connecting segment of the connecting part 50 is connected to the main body part 41. One end of the first connecting segment of the connecting part 50 far from the second connecting segment of the connecting part 50 is above the second connecting segment of the connecting part 50. The first connecting segment of the connecting part 50 and the second connecting segment of the connecting part 50 are integrally formed structures. The first connecting segment of the connecting part 50 extends in the vertical direction, and the second connecting segment of the connecting part 50 extends in the horizontal direction. After the first connecting segment of the connecting part 50 is in connection with the second connecting segment of the connecting part 50, an L-shaped structure is formed. The second connecting segment of the connecting part 50 is connected with the main body part 41 at an included angle. After the second connecting segment of the connecting part 50 is in connection with the main body part 41, an L-shape structure is formed. The main body part 41 includes a first main body segment and a second main body segment sequentially connected in the horizontal direction. The first main body segment is located above the second connecting segment of the connecting part 50, and the end face of the bottom of the second main body segment is lower than the end face of the bottom of the first main body segment. After the main body part 41 is in connection with the clamping rod 42, an L-shaped structure is formed. The clamping rod 42 is connected to the bottom of the second main body segment of the main body part 41.

In this embodiment, the number of the connecting parts 50 is two, and the two connecting parts 50 are arranged opposite each other. The main body part 41 is between the two connecting parts 50. Moreover, the number of the main body parts 41 is two, the two main body parts 41 arranged opposite each other, and the main body parts 41 are connected to the connecting part 50 in a one-to-one correspondence manner. The number of the clamping rods 42 is four, and one of the main body parts 41 is correspondingly connected to two of the clamping rods 42. The clamping rods 42 on the two main body parts 41 are arranged opposite each other. Two connecting parts 50 are distributed along the width direction of the body 10. By this arrangement, the compact structure of the clamping device can be assured. Moreover, with this arrangement, the four clamping rods 42 are divided into two groups, and the two groups of clamping rods 42 are arranged opposite each other. When clamping the clamped object, the four clamping rods 42 are on the outer peripheral surface of the clamped object, ensuring the stability of clamping the object.

In an implementation, the first gripper assembly includes two first clamping portions 30 arranged opposite each other, the first clamping portions 30 are connected to the connecting parts 50 in a one-to-one correspondence manner, and the first clamping portion 30 is between the two connecting parts 50. The connecting part 50 is movably arranged at the bottom of the body 10, and both ends of the connecting part 50 extend to two sides of the body 10. The bottom of the body 10 is formed with a guide slot 61 which is horizontally arranged, and the extension direction of the guide slot 61 is the same as that of the body 10. A guide block is provided at the top of the connecting part 50. The guide block can be movably arranged in the guide slot 61. The section of the guide slot 61 is in an I-shaped shape. By this configuration, the guide block can be prevented from coming out of the guide slot 61 and the moving smoothness of the guide block can be improved. The main body part 41 and the first clamping portion 30 are respectively located at both sides of the body 10, and are connected to the two ends of the connecting part 50 respectively. The first clamping portion 30 is in a block structure, and there is an avoidance space between the top of the first clamping portion 30 and the body 10, so that the top of the clamped object can pass through the avoidance space. This configuration facilitates the first clamping portion 30 to clamp the clamped object, avoiding interference from the body 10 and other components in the clamping action of the first clamping portion 30.

In an implementation, the clamping device further includes a displacement mechanism arranged on the body 10. The displacement mechanism is drive-connected to the first gripper assembly and/or the second gripper assembly to adjust the position of the first gripper assembly and/or the position of the second gripper assembly relative to the body 10. In this embodiment, the displacement mechanism is arranged on the body 10 and is drive-connected to the second gripper assembly to adjust the position of the second gripper assembly relative to the body 10.

In an implementation, the displacement mechanism includes a lifting structure which includes a second driving member 71 and a lifting plate 72. The second driving member 71 is arranged on the body 10. The lifting plate 72 is movably arranged at one side of the body 10, and the lifting plate 72 is parallel to the body 10. The second driving member 71 is drive-connected to the lifting plate 72. The lifting plate 72 is provided with a first limit part 721, and the main body part 41 is slidably connected to the first limit part 721. The second driving member 71 drives the second gripper assembly to rise or descend through the lifting plate 72. By including the lifting structure, automatic lift of the second gripper assembly can be realized, thereby improving the convenience of adjusting the height of the second gripper assembly relative to the body 10. Moreover, in this embodiment, the first driving member 20 is arranged on the body 10, and the first driving member 20 does not need to rise or descend together with the second gripper assembly. In this way, the lifting weight can be reduced, the load of the lifting structure can be reduced, and the flexibility of the lifting action can be improved. When it is necessary to use the first gripper assembly to clamp the object, the second gripper assembly can be raised to avoid interference with the first gripper assembly caused by the second gripper assembly. When it is necessary to use the second gripper assembly to clamp the item, the second gripper assembly can be lowered. In addition, when using the second gripper assembly, its clamping rods are far away from the body, thus the clamping of an object from densely distributed objects can be achieved and the flexibility of the clamping device can be improved.

The first limit part 721 extends in the horizontal direction, and the first limit part 721 can be the first limit slot. The main body part 41 is movably arranged in the first limit slot. In this embodiment, the first limiting part 721 is the first guide rail, two main body parts 41 are distributed along the extension direction of the first guide rail, and the connecting part 50 is movably arranged on the first guide rail. The first driving part 20 drives the two connecting parts 50 to synchronously move towards each other or in opposite directions. The first guide rail has a simple structure and can avoid mutual contact between the main body part 41 and the body 10, improving the moving smoothness of the main body part 41. Moreover, with this configuration, the main body parts 41 can both move in the horizontal direction synchronously, thereby ensuring that the movement stroke of the two main body parts 41 remains consistent during a single clamping process, which ensures that the clamping force on the object from the two main body parts 41 remains consistent, thereby further improving the stability of clamping the object. Moreover, the first guide rail is arranged near the bottom of the lifting plate 72, which can maximize the travel range of the second gripper assembly and facilitate the clamping device to clamp objects at different heights.

The second driving member 71 can be a driving cylinder. The driving cylinder is arranged on the body 10 and drive-connected to the lifting plate 72. This configuration has a simple structure and convenient operation. In this embodiment, the second driving member 71 is a driving motor. The lifting structure further includes a screw rod 73, a screw nut pair 74, and a second limit part 11. The second driving member 71 is drive-connected to the screw rod 73. The screw nut pair 74 is threaded to the screw rod 73. The screw nut pair 74 is connected to the lifting plate 72. The second limit part 11 is provided on the body 10. The lifting plate 72 is slidably connected to the second limit part 11. The second driving member 71 drives the lifting plate 72 to rise or descend along the second limit part 11 through the cooperation of the screw rod 73 and the screw nut pair 74. When adjusting the height of the lifting plate 72 relative to the body 10, the drive motor is started and drives the screw rod 73 to rotate. When the screw rod 73 rotates, it drives the screw nut pair 74 to drive the lifting plate 72 to rise or descend. The screw rod 73 and the screw nut pair 74 have a simple structure and stable transmission. Moreover, the screw rod 73 and the screw nut pair 74 have self-locking function, which can ensure the stability of the lifting plate 72 when it is in a static state, and thus ensure the stability of the second gripper assembly when clamping the object.

In an implementation, the lifting plate 72, the screw rod 73, the screw nut pair 74 and the driving motor are all at the same side of the body 10. The movement direction of the lifting plate 72 and the extension direction of the screw rod 73 are both vertical. The driving motor is arranged near the top of the body 10 and the screw rod 73 is below the driving motor. The first driving member assembly 20 is located at one side of the body 10 away from the lifting plate 72. By this arrangement, the compactness of the overall structure of the lifting device can be assured, thereby facilitating to clamp the clamped object in a narrow space.

In this embodiment, the displacement mechanism further includes a connecting block 75. The connecting block is fixedly connected to the screw nut pair 74. The screw rod 73 passes through the connecting block 75. The connecting block 75 is fixedly connected to the lifting plate 72. Alternatively, the connecting block 75 can be integrally formed with the lifting plate 72. The connecting block 75 can function as a transitional connection, improving the stability of the connection between screw nut pair 74 and lifting plate 72.

The second limit part 11 is vertically arranged. The second limit part 11 can be the second guide rail. The lifting plate 72 is movably arranged on the second guide rail. In this embodiment, the second limit part 11 is the second limit slot which is arranged at one side of the body 10 near the lifting plate 72. A limit block is provided on the lifting plate 72. The limit block is movably arranged in the second limit slot. The second limit slot and the limit block can guide and limit rising or descending of the lifting plate 72, ensuring the smooth movement of the lifting plate 72.

In an implementation, the lifting structure further includes a plurality of guide rods 80. Each of the connecting parts 50 is provided with at least one guide rod 80. The guide rods 80 are slidably connected to the main body parts 41 in a one-to-one correspondence manner. The lifting plate 72 drives the main body parts 41 to rise or descend along the guide rods 80. The connecting part 50 drive the second clamping assembly to clamp the object through the guide rod 80 and the first limit part 721. In this embodiment, the lifting structure includes two guide rods 80, and each connecting part 50 is provided with a guide rod 80. The guide rod 80 is vertically provided on the top surface of the second connecting segment of the connecting part 50. The first main body segment of the main body part 41 movably passes through the guide rod 80. The guide rod 80 has a simple structure and occupies a small space, which can ensure the compactness of the overall structure of the device. Moreover, in this solution, the guide rod 80 is in cooperation with the connecting part 50 and the second limit slot is in cooperation with the limit block on the lifting plate 72, which can ensure the smoothness of synchronous rising or descending of the connecting part 50 and the lifting plate 72.

In an implementation, the second driving member 71 is above the lifting plate 72. The lifting structure further includes a limit sensor and a baffle 751. The limit sensor is arranged below and adjacent to the second driving member 71. The baffle 751 is arranged above the lifting plate 72. The baffle 751 can limit the displacement of the lifting plate 72 in combination with the limit sensor. The limit sensor is electrically connected to the second driving member 71. When the lifting plate 72 rises to approach the second driving member 71, the limit sensor and the baffle 751 sense each other, the limit sensor transmits the position signal of the lifting plate 72 to the second driving member 71, the second driving member 71 stops, and the lifting plate 72 stops rising. By making the baffle 751 and the limit sensor in cooperation, the displacement of the lifting plate 72 can be limited and collision between the lifting plate 72 and the second driving member 71 can be avoided.

The clamping device further includes a quick-change connecting plate 91 and a pneumatic quick-change connector 92. The quick-change connecting plate 91 is arranged on the body 10, and the pneumatic quick-change connector 92 is arranged on the quick-change connecting plate 91. In the use, the pneumatic quick-change connector 92 can be fixed on a peripheral mechanical arm, and the entire clamping device can be controlled to move through the mechanical arm. By providing the pneumatic quick-change connector 92 and the quick-change connecting plate 91, the convenience of connecting the entire clamping device with the peripheral mechanical arm can be improved, improving the efficiency of installing the clamping device to the peripheral mechanical arm.

According to an embodiment of the present disclosure, a clamping robot includes a motion mechanism and a clamping device mentioned above. The motion mechanism is drive-connected to the clamping device and can drive the clamping device to move. For example, the motion mechanism can be a robotic arm with multi degree of freedom, an XYZ three-axis translation mechanism or the like.

Various embodiments of the present disclosure have been described above. The above description is exemplary but not exhaustive, and the present disclosure is not limited to the disclosed embodiments. Without deviating from the scope and spirit of the various embodiments illustrated, many modifications and changes are obvious to a person skilled in the art. The selection of terms used in this text aims to best explain the principles, the practical applications of various embodiments, or the improvements to the technologies in the market, or to enable other ordinary technical persons in the art to understand the disclosed embodiments.

What is claimed is:

1. A clamping device, comprising:
a body;
a first driving member arranged on the body; and
a first gripper assembly and a second gripper assembly which are arranged independently, wherein the first driving member is drive-connected to the first gripper assembly and the second gripper assembly respectively so as to drive the first gripper assembly and the second gripper assembly to clamp an object separately.

2. The clamping device according to claim 1, wherein the first gripper assembly and the second gripper assembly have different structures, the first gripper assembly and the second gripper assembly are arranged at two sides of the body respectively, and a position of the first gripper assembly and/or a position of the second gripper assembly relative to the body is adjustable.

3. The clamping device according to claim 1, wherein the first gripper assembly comprises a plurality of first clamping portions, each of the plurality of first clamping portions has a first clamping surface, and the plurality of first clamping portions are in cooperation with each other through a plurality of said first clamping surfaces to clamp the object.

4. The clamping device according to claim 3, wherein a contact region between the first clamping surface of the first clamping portion and the object to be clamped is at a cambered surface or a planar surface of the first clamping surface, or there are a plurality of contact regions between the first clamping surface of the first clamping portion and the clamped object, and an angle is formed between the plurality of contact regions of the first clamping surface.

5. The clamping device according to claim 3, wherein the number of the first clamping portions is two, the two first clamping portions are arranged opposite each other, and the first clamping surface of the first clamping portion is V-shaped; wherein the first gripper assembly further comprises:
a first anti-slip structure on the first clamping surface; and/or,
a first elastic member on the first clamping surface.

6. The clamping device according to claim 1, wherein the second gripper assembly comprises a plurality of clamping rods which cooperate with each other to clamp the object.

7. The clamping device according to claim 6, wherein the clamping rod comprises a first clamping segment which has a second clamping surface for clamping the object, and the second clamping surface of at least one of the clamping rods is a planar surface or a cambered surface;
wherein a second anti-slip structure is provided on the second clamping surface.

8. The clamping device according to claim 6, wherein the clamping rod is a column, and the number of the clamping rods is three or more; wherein the clamping rod further comprises a second clamping segment which is connected to the first clamping segment and located above the first clamping segment, and a second elastic member is provided on the second clamping segment.

9. The clamping device according to claim 6, wherein the second gripper assembly further comprises a plurality of main body parts, each of the main body parts is connected to at least one of the clamping rods, and the clamping rod is below the main body part;
wherein the first driving member is drive-connected to the main body part, and the first driving member drives the clamping rod to move through the main body part.

10. The clamping device according to claim 9, further comprising a plurality of connecting parts, and each of the connecting partings is connected to at least one of the main body parts;
wherein the first driving member is drive-connected to the connecting part, and the first driving member drives the main body part to move through the connecting part.

11. The clamping device according to claim 10, wherein the connecting part comprises a first connecting segment and a second connecting segment connected at an included angle, the first driving member is connected to the first connecting segment of the connecting part, and the second connecting segment of the connecting part is connected to the main body part.

12. The clamping device according to claim 11, wherein one end of the first connecting segment of the connecting part far from the second connecting segment of the connecting part is above the second connecting segment of the connecting part, and the second connecting segment of the connecting part is connected with the main body part at an included angle;
wherein an L-shaped structure is formed after the first connecting segment of the connecting part is in connection with the second connecting segment of the connecting part, an L-shaped structure is formed after the second connecting segment of the connecting part is in connection with the main body part, and an L-shaped structure is formed after the main body part is in connection with the clamping rod.

13. The clamping device according to claim 10, wherein the number of the plurality of connecting parts is two, the two connecting parts are arranged opposite each other, and the main body part is between the two connecting parts; wherein the number of the plurality of main body parts is two, the two main body parts are arranged opposite each other, and the main body parts are connected to the connecting parts in a one-to-one correspondence manner;
wherein the number of the plurality of clamping rods is four, one of the main body parts is correspondingly connected to two of the clamping rods, and the clamping rods on the two main body parts are arranged opposite each other.

14. The clamping device according to claim 10, wherein the number of the plurality of connecting parts is two, the two connecting parts are arranged opposite each other; wherein the first gripper assembly comprises two first clamping portions arranged opposite each other, the first clamping portions are connected to the connecting parts in a one-to-one correspondence manner, and the first clamping portion is between the two connecting parts.

15. The clamping device according to claim 1, wherein the clamping device further comprises a displacement mechanism arranged on the body, and the displacement mechanism is drive-connected to the first gripper assembly and/or the second gripper assembly to adjust a position of the first gripper assembly and/or a position of the second gripper assembly relative to the body.

16. The clamping device according to claim 10, wherein the clamping device further comprises a displacement mechanism arranged on the body, and the displacement mechanism is drive-connected to the second gripper assembly to adjust a position of the second gripper assembly relative to the body; wherein the displacement mechanism comprises a lifting structure which comprises:
a second driving member arranged on the body; and
a lifting plate, the second driving member being drive-connected to the lifting plate, the lifting plate being provided with a first limit part, the main body part being slidably connected to the first limit part, and the second driving member driving the second gripper assembly to rise or descend through the lifting plate.

17. The clamping device according to claim 16, wherein the lifting structure further comprises:
a screw rod, the second driving member being drive-connected to the screw rod;
a screw nut pair, the screw nut pair being thread connected to the screw rod, and the screw rod nut pair being connected to the lifting plate; and
a second limit part, the second limit part being arranged on the body, the lifting plate being slidably connected to the second limit part, and the second driving member driving the lifting plate to rise or descend along the second limit part through the cooperation of the screw rod and the screw nut pair; wherein the second driving member is above the lifting plate, and the lifting structure further comprises:
a limit sensor arranged below and adjacent to the second driving member; and
a baffle arranged above the lifting plate and being in cooperation with the limit sensor to limit the displacement of the lifting plate.

18. The clamping device according to claim 16, wherein the lifting structure further comprises:
a plurality of guide rods, each of the connecting parts being provide with at least one of the guide rods, the guide rods being slidably connected to the main body parts in a one-to-one correspondence manner, the lifting plate driving the main body part to rise or descend along the guide rod, and the connecting part driving the second gripper assembly to clamp the object through the guide rod and the first limit part.

19. The clamping device according to claim 1, further comprising:
a quick-change connecting plate and a pneumatic quick-change connector, the quick-change connecting plate being arranged on the body, and the pneumatic quick-change connector being arranged on the quick-change connecting plate.

20. A clamping robot, comprising a motion mechanism and a clamping device according to claim 1, wherein the motion mechanism is drive-connected to the clamping device to drive the clamping device to move.
